(19) United States
(12) Patent Application Publication
(10) Pub. No.: US 2015/0161266 A1
(43) Pub. Date: Jun. 11, 2015

(54) SYSTEMS AND METHODS FOR MORE EFFICIENT SOURCE CODE SEARCHING

(71) Applicants: Michael Conradt, Muenchen (DE); James Benjamin St. John, Eichenau (DE); Alexander Neubeck, Obermichelbach (DE)

(72) Inventors: Michael Conradt, Muenchen (DE); James Benjamin St. John, Eichenau (DE); Alexander Neubeck, Obermichelbach (DE)

(73) Assignee: GOOGLE INC., Mountain View, CA (US)

(21) Appl. No.: 13/536,598

(22) Filed: Jun. 28, 2012

(51) Int. Cl. G06F 17/30

(52) U.S. Cl. CPC G06F 17/30867

(57) ABSTRACT

Systems and methods are disclosed for searching a corpus using regular expressions. The method includes determining whether a received query has parameters that include a regular expression and creating an automaton representation of the regular expression, the automaton having a starting node, a number of termination nodes, and at least one edge between nodes. The method further includes traversing the automaton from the termination nodes to the starting node to determine a suffix array range for the starting node and using the suffix array range to identify documents in the corpus. The method may also include determining whether the query parameters match parameters for a stored high-cost recurring query and identifying documents associated with prepared results for the high-cost recurring query. The method may generate search results including the documents associated with the prepared results and at least some documents identified using the suffix array range.

### TECHNICAL FIELD

This description relates to searching large document corpora and, more specifically, to systems and methods for efficiently searching a source code corpus using regular expressions.

### BACKGROUND

Search engines may process many queries each day. Search engines also frequently see recurring queries, meaning that users submit the same query multiple times. Additionally, some of the recurring queries may require more processing resources than others, making the execution of the query expensive and, in some cases, impacting the performance of other queries.

One example of an expensive query is a query that uses a regular expression. Regular expressions are used to find matches between strings. Regular expressions have several operators including ? (zero or one), * (zero or more), +(one or more), and |(the OR operator). For example, the regular expression “ab?c” will match the strings “ac” and “abc,” the expression ab+c will match “abc,” “abbc,” “abbbc,” but not “ac,” and the expression a(b|c)d will match the strings “abd” and “acd.” Because of the flexibility offered by regular expression operators, searching for documents responsive to a query using a regular expression in a brute-force manner can be expensive, especially when searching in a large collection of documents. For this reasons most web-based searches do not support full regular expression searches. But some search engines do support regular expressions, such as search engines for source code collections. To narrow the number of documents early on, search systems that support regular expressions may use a prefilter tree. A prefilter tree assigns each term of the regular expression an AND/OR tree of strings. An example of a prefilter tree implementation can be found at http://code.google.com/p/re2/source/browse/re2/. However, prefilter trees suffer from several drawbacks including: 1) the loss of ordering information for the ?, *, and + operators; 2) the ? and * operator terms are ignored and the + operator terms are partially ignored because only one match is considered; and 3) the prefilter tree can become arbitrarily large, potentially growing exponentially, and creating a bottleneck because in such situations the corresponding subtree is replaced by a match everything node. Thus the prefilter trees sometimes improve query response time, but may fail to provide acceptable search results and may sometimes increase query response time.

As indicated above, regular expressions may be used for searches in a source code collection. A source code collection may include a code storage system that provides version control, a designated directory or directories on one or more computing systems, or a combination of these linked, for example, over the internet. Source code collections may be small, hundreds of files, or may be large, with millions of files. Searching a small corpus may be straightforward, but processing resources may be taxed when searching a large collection, especially to support searching using all regular expression operators, including expensive combinations of regular expression operators. For example, the regular expressions return[̂″]*, which requires finding all occurrences of “return” that are not followed by quotation marks, YZ\b, which finds all words ending with “YZ”, and \s+$, which finds all lines that end with spaces or tabs rather than visible characters, are all expensive in processing terms. Additionally, regular expressions that match many of the documents in the corpus can be expensive since not many documents can be prefiltered. Furthermore, source code searches also often require a full set of search results, not just the top 20 or 40 results that many web-based search engines provide. Obtaining the full set of search results increases the cost of running any query, let alone a query using a regular expression, and increases the amount of time needed to generate and present the search results to the query requestor, otherwise known as the query latency time.

Therefore, a challenge remains in searching source code to provide time-efficient, cost-effective, and complete search results for searches that use regular expressions.

### SUMMARY

One aspect of the disclosure can be embodied in a method for prefiltering documents for a query that includes receiving a regular expression and creating an automaton representation of the regular expression, the automaton having a starting node, a number of termination nodes, and at least one edge between nodes. The method may also include traversing the automaton from the termination nodes to the starting node to identify a suffix array range for the starting node and using the suffix array range to identify documents responsive to the regular expression. In some implementations traversing the automaton may include using a prepend operation to move between nodes of the automaton. In such implementations the prepend operation may include determining a value represented by an edge connecting a particular node to another node, appending the value to suffix array entries corresponding to the another node; and determining a suffix array range corresponding to the particular node based on the appending. In some implementations creating the automaton representation may include identifying a regular expression operator that creates a loop in the automaton and unrolling the loop at least one time, causing the automaton to have at least two termination nodes. In such implementations the unrolling may occur a number of times, with the number being dynamically determined.

These and other aspects can include one or more of the following features. For example, each of the number of termination nodes may correspond to a suffix array range representing the entire suffix array. As another example, as part of identifying the suffix array range for the starting node, the method further include merging neighboring intervals of the suffix array range when a gap between the neighboring intervals meets a first threshold or when the number of intervals in the suffix array range exceeds a second threshold.

In another aspect a system is disclosed that includes one or more processors and a memory storing instructions that, when executed by the one or more processors, perform operations. The operations may include identifying expensive recurring queries in a log file of queries submitted to a search engine, wherein the expensive recurring queries are expensive based on a single query execution. The operations may also include storing query parameters of the identified queries in a data store, receiving a query including query parameters from a user, and determining whether the query parameters match any of the stored query parameters in the data store. When it is determined that the query parameters match parameters for a particular stored query, the operations may include using prepared results associated with the particular query to generate data used to display search results to the user. In some implementations the operations also include determining whether the query includes a regular expression and creating, when the query includes a regular expression, an automaton representation of the regular expression. The automaton may have a starting node, a number of termination nodes, and at least one edge between nodes. The operations may also include traversing the automaton from the termination nodes to the starting node to identify a suffix array range for the starting node, using the suffix array range to identify documents, and using at least some of the identified documents to generate data used to display the search results to the user.

These and other aspects can include one or more of the following features. For example, entries in the log file older than a specified date may not be considered when identifying expensive recurring queries. In some implementations, identifying expensive recurring queries may include instructions that cause the one or more processors to locate a request to view all results for a particular query or instructions that cause the one or more processors to determine an amount of time that elapsed to arrive at a result for a particular query and identify the particular query as an expensive query when the amount of time that elapsed exceeds a threshold. In some implementations, identifying recurring queries may include instructions that cause the one or more processors to identify a number of documents searched by a particular query and identify the particular query as an expensive query when the number of documents searched exceeds a threshold.

As another example, using the prepared results may include instructions that cause the one or more processors to generate a first page of search results for display to the user from the prepared results, wherein the first page of search results is generated upon determining that the query parameters match. In such an implementation the instructions may cause the one or more processors to execute the query and identify execution results, wherein the execution results are used to generate a second page of search results for display to the user. Additionally the second page may be displayed to the user in response to receiving an instruction from the user to display a next page.

In some implementations, the prepared results associated with the particular query may be used to generate data displayed to the user as the user types the query parameters. In some implementations the instructions may cause the one or more processors to receive a document for indexing, determine whether the document matches parameters of the particular query in the data store, and add the document to the prepared results associated with the particular query when it is determined that the document matches the parameters of the particular query, wherein the receiving, determining, and adding occur independently from execution of the particular query. In such implementations, the instructions may further cause the one or more processors to perform operations including notifying a user associated with the particular query when the document is added to the prepared results or archiving the prepared results before adding the document to the prepared results.

In another aspect, a computer-readable storage device for efficiently searching a source code repository may have recorded and embodied thereon instructions that, when executed by one or more processors of a computer system, cause the computer system to receive a query including query parameters from a user, determine whether the query parameters include a regular expression, and create, when the query parameters include a regular expression, an automaton representation of the regular expression. The automaton may have a starting node, a number of termination nodes, and at least one edge between nodes. The instructions may also cause the computer system to traverse the automaton from the termination nodes to the starting node to determine a suffix array range for the starting node and use the suffix array range to identify documents in the source code repository. In some implementations, the instructions may also cause the computer system to determine whether the query parameters match query parameters stored in a data store, wherein the data store identifies expensive recurring queries and, when it is determined that the query parameters match parameters for a particular query stored in the data store, to identify documents associated with prepared results for the particular query. The instructions may also cause the computer system to generate data used to display search results to the user, the search results including the documents associated with the prepared results and at least some of the documents identified using the suffix array range.

In some implementations, the instructions further cause the computer system to receiving a document for indexing and determining whether the document is responsive to the particular query in the data store. When it is determined that the document is responsive, the instructions may also cause the computer system to add the document to the prepared results associated with the particular query. In such implementations the receiving, determining, and adding occur independently from execution of the particular query. In some implementations, expensive recurring queries include queries derivable from a parent query and as part of identifying documents associated with prepared results for the particular query the instructions further cause the computer system to identify the particular query as a member of a family of queries, identify prepared search results for the family of queries, and search the prepared search results for the family of queries for documents matching the particular query.

In one aspect a computer-implemented method for prefiltering documents for a query includes receiving a regular expression and creating an operator tree for the regular expression. The operator tree may have a root node and a number of child nodes. The method may also include traversing the child nodes in reverse order to identify a suffix array range for the root node and using the suffix array range to identify documents responsive to the regular expression. In some implementations traversing the child nodes includes determining a first suffix array range for a number of repetitions of a repeated term in the regular expression, determining a second suffix array range for the number of repetitions plus one of the term repetitions, and comparing the first suffix array range and the second suffix array range. In such implementations the method may also include avoiding the determining of a third suffix array range for the number of repetitions plus two for the repeated term based on the comparison of the first suffix array range and the second suffix array range.

The details of one or more implementations are set forth in the accompanying drawings and the description below. Other features will be apparent from the description and drawings, and from the claims.

### BRIEF DESCRIPTION OF DRAWINGS

FIG. 1 illustrates an example system in accordance with the disclosed subject matter.

FIG. 2 is a flow diagram illustrating a process for efficiently providing search results for high-cost recurring queries, consistent with disclosed implementations.

FIG. 3 is a flow diagram illustrating a process for updating prepared results for a high-cost recurring query, consistent with disclosed implementations.

FIG. 4 is an example of document content and a suffix array for the document content.

FIG. 5 is an example of a non-deterministic automaton for the regular expression “an?a.”

FIG. 6 shows an example non-deterministic automaton for the regular expression “a(na)+s.”

FIGS. 7-8 show example non-deterministic automaton for the regular expression “a(na)+s,” consistent with disclosed implementations.

FIG. 9 is a flow diagram illustrating a process for using a suffix array to prefilter documents matching a regular expression, consistent with disclosed implementations.

FIG. 10 illustrates example pseudo code for traversing the non-deterministic automaton to determine a suffix array range, consistent with disclosed implementations.

FIG. 11 shows an example of a computer device that can be used to implement the described techniques.

FIG. 12 is a flow diagram illustrating another process for using a suffix array to prefilter documents matching a regular expression, consistent with disclosed implementations.

FIG. 13 shows an example operator tree for the regular expression “a(na)+s,” consistent with disclosed implementations.

FIG. 14 illustrates an example of pseudo code for traversing the operator tree to determine a suffix array range for the root node, consistent with disclose implementations.

Like reference symbols in the various drawings indicate like elements.

### DETAILED DESCRIPTION

Disclosed implementations provide more efficient source code searching systems and methods that reduce query response time while increasing the quality of the search results. For example, search engines frequently log issued queries. The logs can track each query, the number of results it returned, the number of documents searched, how long it took to execute, when it was submitted, etc. Systems and methods consistent with disclosed implementations improve latency times for returning query results to users by identifying expensive recurring queries, computing the search results for these queries, and serving the pre-computed results once the exact query is entered at a later time to improve the response time.

For example, in some implementations a search system may analyze log files to identify expensive recurring queries. Identifying such queries and preparing a result list ahead of time may allow the search system to reduce the system resources needed to process the query and to reduce the amount of time a user must wait to receive search results. Once the system identifies a high-cost recurring query, the system may store the parameters of the query in a data store, such as a database, a flat file, etc., so that the search system can recognize the query when it is submitted again. In addition to adding newly identified queries to the stored list, some implementations may also delete queries from the list. For example, before a query identification process begins, the search system may mark each currently stored query for deletion. When the search system finds an expensive recurring query in the log it may remove the deletion mark from the query, if it already exists, or may add the query to the stored list, if the query does not already exist. Any stored queries still marked for deletion after the log records have been analyzed may then be deleted. When the search system has finished identifying the high-cost recurring queries have been identified, the system may prepare initial prepared results by executing the query and caching the results. Of course other implementations may use other methods of removing queries from the list of high-cost recurring queries.

However, the cached result list may quickly become outdated. To increase the quality of the prepared results, some implementations may update the prepared results as new documents are added to the corpus and/or as documents in the corpus change. Updating the prepared results may be a step added to the search engine's indexing process that addresses new documents, updated documents, and deleted documents. As a document is deleted or added to the index, the document may be inspected to determine if the document satisfies any of the query parameters for the stored high-cost queries. If the search engine finds a match, then appropriate action is taken, such as deleting the document from the prepared results or inserting the document into the prepared results. In this manner the prepared results may maintain their freshness and do not become stale like other cached results. In some implementations, as documents are added to the prepared results, the user who submitted the recurring query may be notified that new results are available for viewing.

In addition to identifying expensive recurring queries and to creating and maintaining prepared results for those queries, disclosed implementations may include methods of improving the query latency when responding to queries that use regular expressions. As indicated above, search systems that currently support full regular expression searching may use prefilter trees to initially reduce the number of documents searched. But the prefilter trees can cause many responsive documents to be skipped and in some circumstances may even increase query latency. To provide more accurate search results while still improving query latency by minimizing the documents searched, systems and methods of using a suffix array are disclosed as an alternative to building a prefilter tree for each regular expression. In some implementations the system may build a non-deterministic automaton and use the suffix array to traverse the automaton backwards, i.e., from the terminal node(s) to the beginning node, to identify documents possibly responsive to the regular expression. In other implementations the system may prefilter using a regular expression operator tree, traversing the children of the root node backwards to determine the documents possibly responsive to the regular expression. The system may return at least some of the matching documents for inclusion in the query results.

In some implementations a search system may use a combination of the features just discussed. For example, queries using regular expressions may be identified as expensive recurring queries and have prepared results generated. When a user resubmits the query, the system may generate a result list based on the prepared results and may also use a suffix array to prefilter matching documents. In one such implementation, the system may present documents from the prepared results on a first page and perform the query execution, using the suffix array prefiltering, in the background so that additional results can be presented to the user when the query execution completes.

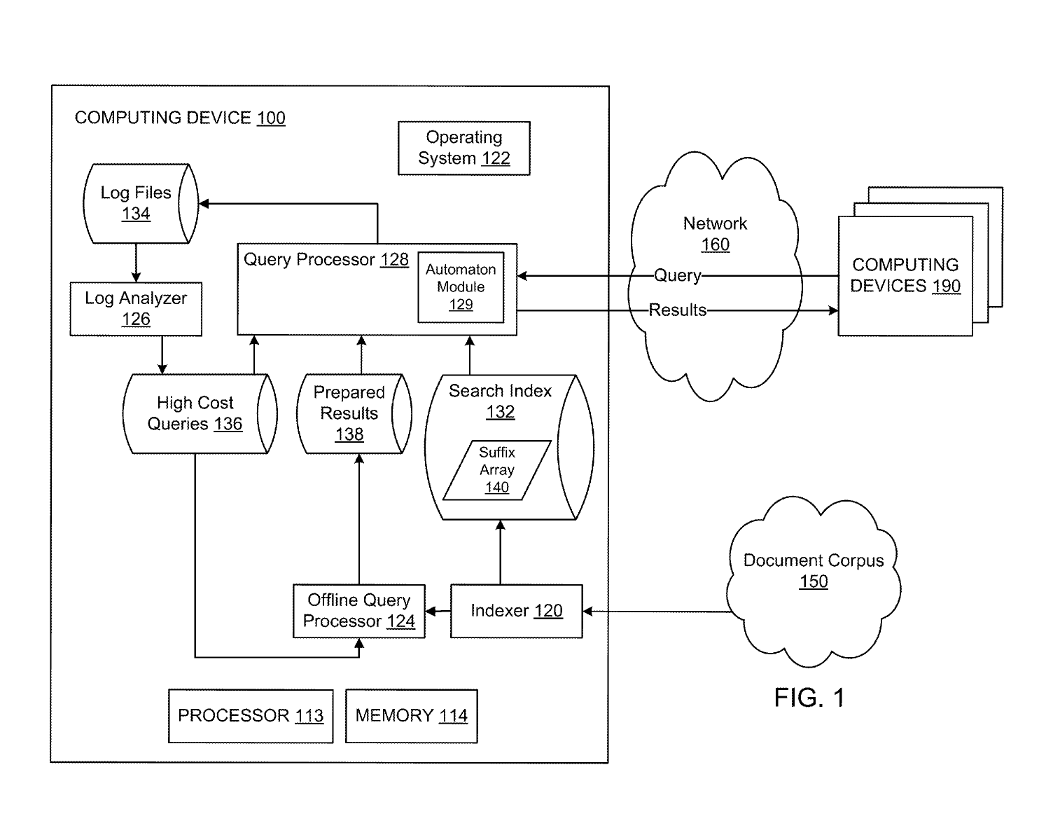

FIG. 1 is a block diagram of a computing device 100 in accordance with an example implementation. The computing device 100 may be used to implement the source code search techniques described herein. The depiction of computing device 100 in FIG. 1 is described as a search system for a source code corpus. Source code may include files of any type that contain statements intended to be interpreted by a processor of a computing device, whether directly or through compilation or interpretation. But, it will be appreciated that the search techniques described may be used to search other corpora where regular expression searches are supported, such as DNA repositories, library collections, or any other type of document repositories. Accordingly, documents, as used herein, may refer to source code files or generically to any files that contain text, data, or other information.

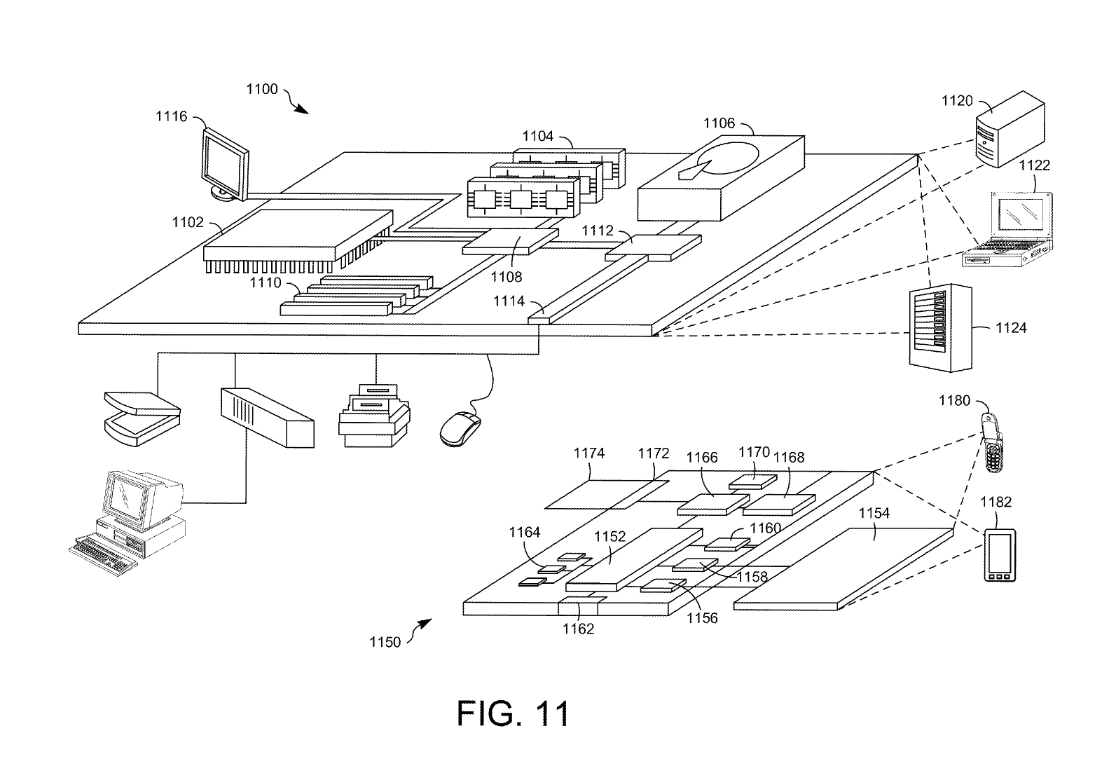

The computing device 100 may be a computing device that takes the form of a number of different devices, for example, a standard server, a group of such servers, or a rack server system. In some implementations, computing device 100 may be implemented in a personal computer, or a laptop computer. The computing device 100 may be an example of computer device 1100, as depicted in FIG. 11.

Computing device 100 can include one or more processors 113 configured to execute one or more machine executable instructions or pieces of software, firmware, or a combination thereof. The computing device 100 can include an operating system 122 and one or more computer memories 114, for example a main memory, configured to store data, either temporarily, permanently, semi-permanently, or a combination thereof. The memory 114 may include any type of storage device that stores information in a format that can be read and/or executed by processor 113. Memory 114 may include volatile memory, non-volatile memory, or a combination thereof. In some implementations memory 114 may store modules, for example modules 120-129. In some implementations one or more of the modules may be stored in an external storage device (not shown) and loaded into memory 114. The modules, when executed by processor 113, may cause processor 113 to perform certain operations.

For example, in addition to operating system 122, the modules may also include an indexer 120, an offline query processor 124, a log analyzer 126, a query processor 128, and an automaton module 129. Indexer 120 may process documents from a document corpus 150 to create search index 132. Indexer 120 may work with offline query processor 124 to update prepared results 138 stored for expensive recurring queries. Log analyzer 126 may examine log files 134 to identify high-cost recurring queries and store the query parameters from the identified queries in high-cost queries data store 136. Query processor 128 may execute queries submitted from computing devices 190 and return the query results. In some implementations, query processor 128 may include an automaton module 129 that builds an automaton for a query having a regular expression and traverses the automaton in reverse order using suffix array 140.

Computing devices 190 may be any type of computing device in communication with computing device 100, for example, over network 160. Computing devices 190 may include desktops, laptops, netbooks, tablet computers, mobile phones, smart phones, etc. In some embodiments, computing device 190 may be part of computing device 100 rather than a separate computing device. Computing device 100 may also include a user interface module (not shown) that allows the user to access the computing device 100. In some implementations the user interface module may run on computing device 190. Document corpus 150 may be stored in a memory storage device as part of computing device 100 or on a number of computing devices communicatively connected to computing device 100.

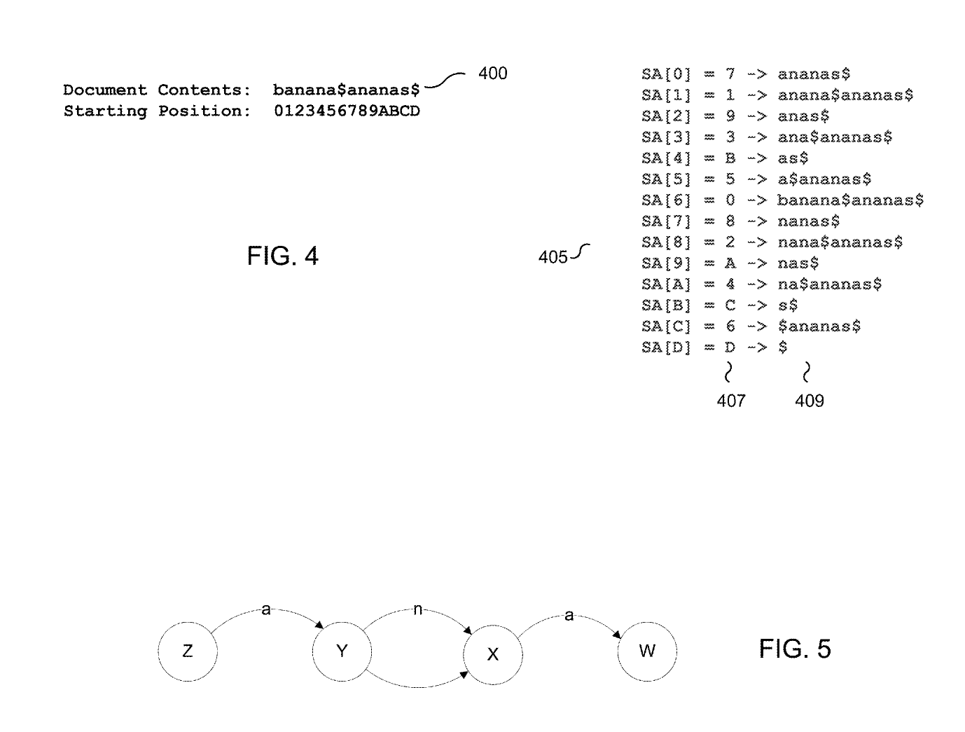

Search index 132 may be an index used to search the document corpus 150 for documents responsive to a query. In some implementations search index 132 may include suffix array 140. A suffix array is a data structure that stores like suffixes together. FIG. 4 is an example of a suffix array 405 for a document 400 containing the text “banana ananas.” The $ symbol of the suffix array 405 indicates white space, e.g., a word separator. In a suffix array that includes multiple documents from a corpus, a different symbol may be used to indicate the boundaries between documents. For convenience suffix array 405 of FIG. 4 shows the document contents 409 represented by the document position 407 in the suffix array, but it is understood that suffix array 405 will likely not store the data shown in document contents 409. Additionally, in some implementations, the suffix array does not store the document position 407 but may use a range query data structure to determine the document position 407 based on the index of the suffix array. In this example the document position is represented by hexadecimal numbers.

Log files 134 may be data produced by query processor 128 when responding to queries and may contain various types of information. For example, log files 134 may contain information that allows log analyzer 126 to determine how long it took to identify all matching results for a query rather than just the best matching results, how many documents were searched to generate the search results, whether a user requested to see all occurrences, etc. For example, in some implementations the search results may include a link indicating that some results may have been omitted, such as a “might be more” link. User selection of this link indicates that the user has requested to see all results.

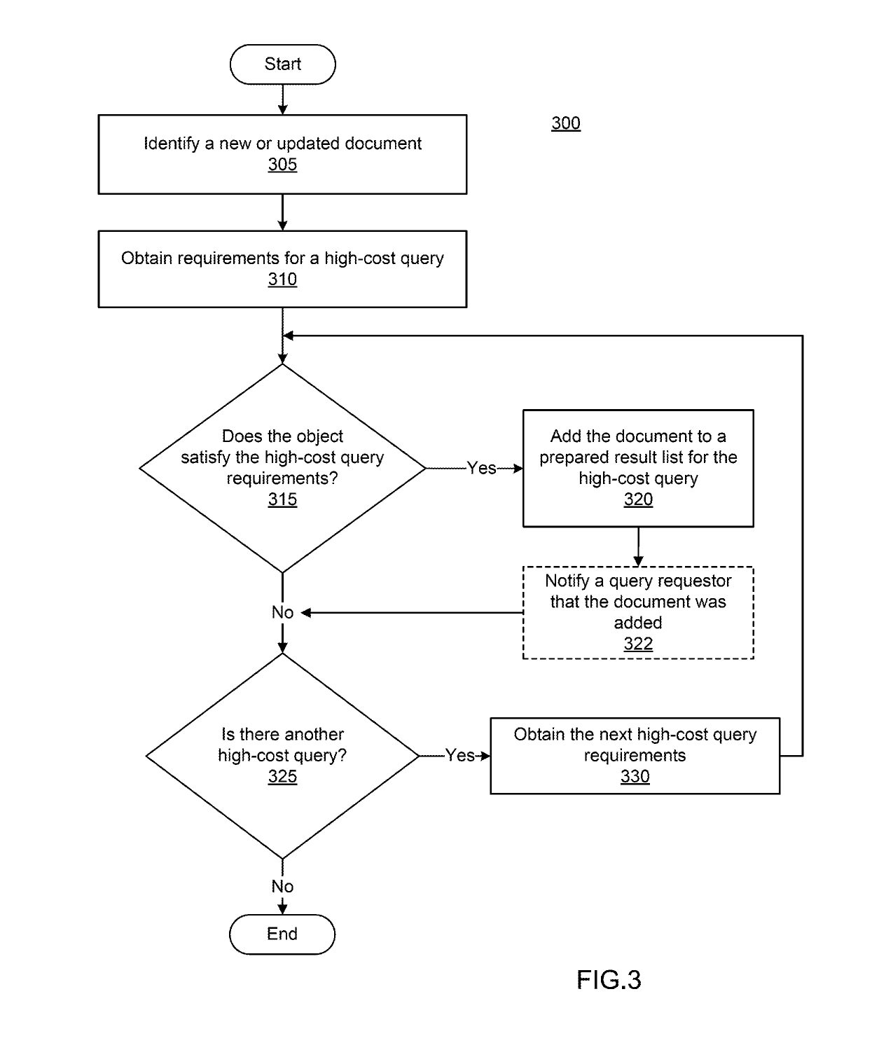

High-cost queries 136 may be a collection of queries identified by log analyzer 126. High-cost queries 136 may contain the information needed to identify a particular query when a requestor submits the query again. For example, high-cost queries 136 may contain the query parameters, which indicate what is searched and the operators used in the search. For example, query parameters may include a regular expression and/or two keywords separated by the operator AND. High-cost queries 136 may be created and maintained by log analyzer 126 and used by query processor 128. Prepared results 138 may be a list of documents from the document corpus 150 that are responsive to queries stored in the high-cost queries 136. Log analyzer 126 may create initial prepared results 138 for each query in the high-cost queries 136. Offline query processor 124 may update the prepared results 138 as new documents are indexed, as will be explained in further detail with regard to FIG. 3. Prepared results 138 may include document identifiers, a document file name and location, the locations of matches within the file or document, or any other information that allows the content of the document to be located. Each query stored in high-cost queries 136 may have an associated entry in prepared results 138.

In some implementations, high-cost queries 136 may include a family of queries. In such implementations the high-cost queries 136 may contain the information needed to identify queries that can be derived from the stored high-cost recurring query. For example, log analyzer 126 may encounter three queries in log files 134: “file=HELLO search=AUTH(csmith)”, “file=HELLO search=AUTH(jdoe)”, and “file=HELLO search=AUTH(sjones).” Log analyzer 126 may determine that the query “file=HELLO search=AUTH(*)” is a parent query in a recurring family because only the user name that follows the AUTH search term changes. Accordingly, log analyzer 126 may store information in high-cost queries 136 that allows subsequent queries to be identified as derived from the parent query.

In implementations where high-cost queries 136 include family queries, the offline query processor 124 may store prepared results 138 for the parent query. In such implementations, when a subsequent query is recognized as being derived from the parent query, the query processor 128 may return prepared results 138 that match the subsequent query, rather than returning all prepared results 138 that match the parent query.

Document corpus 150 may be any collection of documents, whether stored in a single location or a plurality of locations, accessible by indexer 120. For example, document corpus 150 may be a source code repository stored on a single computer using a version control system, or the document corpus 150 may be source code stored on a plurality of computers connected through a network, such as the Internet. In some implementations, one or more of suffix array 140, search index 132, prepared results 138, high-cost queries 136, and log files 134 may be stored in memory 114, for example in main memory or in disk memory. In some implementations one or more of suffix array 140, search index 132, prepared results 138, high-cost queries 136, and log files 134 may be stored in a memory device external to computing device 100 and, for example, accessible to system 100 via a network, such as network 160.

Computing device 100 may be in communication with the computing devices 190 over network 160. Network 160 may be for example, the Internet or the network 160 can be a wired or wireless local area network (LAN), wide area network (WAN), etc., implemented using, for example, gateway devices, bridges, switches, etc. Via the network 160, the computing device 100 may communicate with and transmit data from computing devices 190. In some implementations computing devices 190 may be incorporated into and part of computing device 100, making network 160 unnecessary.

Although FIG. 1 nominally illustrates a single computing device executing the source code search system, it may be appreciated from FIG. 1 and from the above description that, in fact, a plurality of computing devices, e.g., a distributed computing system, may be utilized to implement the source code search system. For example, any of components 120-129 may be executed in a first part of such a distributed computing system, while any other of components 120-129 may be executed elsewhere within the distributed system. For example, query processor 128 may be executed from a first server while log analyzer 126 may be executed from a second server in the distributed system.

More generally, it may be appreciated that any single illustrated component in FIG. 1 may be implemented using two or more subcomponents to provide the same or similar functionality. Conversely, any two or more components illustrated in FIG. 1 may be combined to provide a single component which provides the same or similar functionality. In particular, as referenced above, the search index 132, the log files 134, the high cost queries 136, and the prepared results 138, although illustrated as stored using computing device 100, may in fact be stored separately from the computing device 100. Thus, FIG. 1 is illustrated and described with respect to example features and terminologies, which should be understood to be provided merely for the sake of example, and not as being at all limiting of various potential implementations of FIG. 1 which are not explicitly described herein.

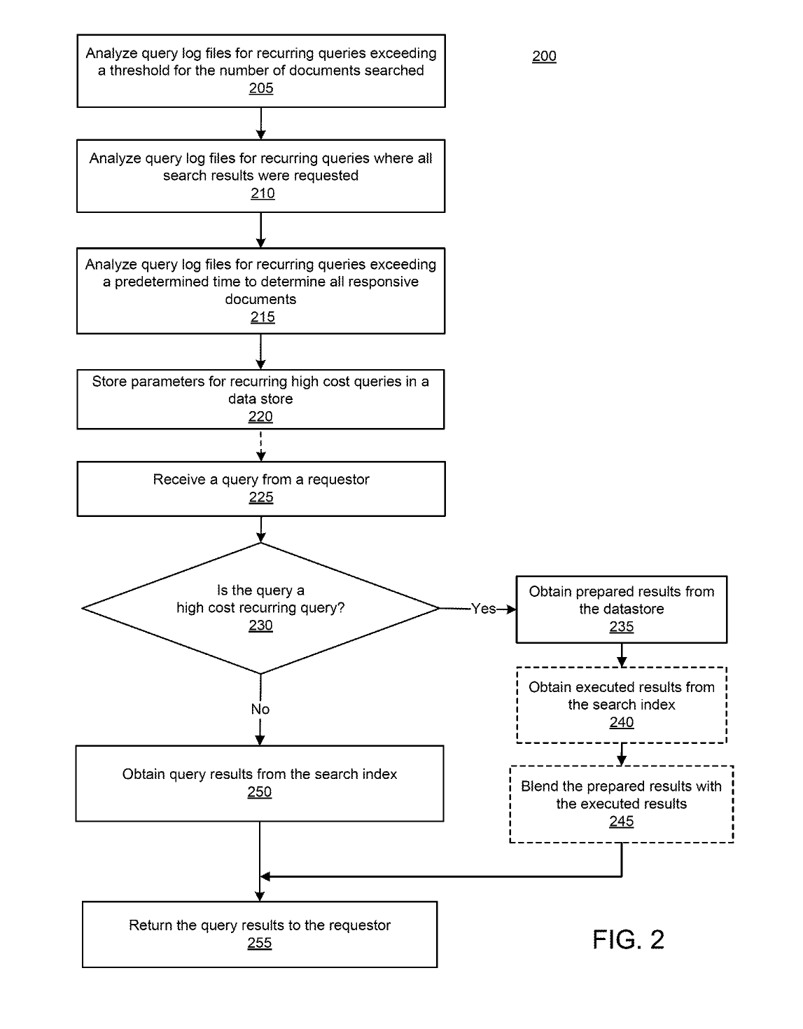

FIG. 2 is a flow diagram illustrating a process 200 for efficiently providing search results for high-cost recurring queries, consistent with disclosed implementations. A source code search system may use process 200 to identify high-cost recurring queries and use prepared results to decrease the query latency. For example, a log analyzer of the source code search system, such as log analyzer 126, may perform steps 205 to 220 as requested or as part of a scheduled process, such as a daily, weekly, bi-weekly process, etc. A query processor of the source code search system, such as query processor 128, may perform steps 225 to 255 after receiving a query from a query requestor. As indicated by the dashed line between steps 220 and 225, the log analyzer and query processor may run the steps independently of each other, including running the steps concurrently or separated by significant amounts of time.

At step 205, the log analyzer may analyze query log files, such as log files 134, for expensive recurring queries. The log analyzer may identify recurring queries by, for example, matching query parameters or query identifiers. In some embodiments a query must recur a predetermined number of times before the log analyzer considers the query recurring. For example, the query may need to recur 3 or more times in the log files for the log analyzer to consider the query recurring. In some implementations the log analyzer may only analyze log records for a specified time period, such as log records for the last week, two weeks, a month, six months, etc. The time period may be determined by the amount of activity occurring in the search system. For example, search systems with a high volume of daily queries may consider a query recurring if the query appears once every two days but search systems with a low volume of daily queries may consider a query recurring if it occurs every week or two weeks. In some implementations the time period may be set and modified by a system administrator or other user.

Once a query has been identified as recurring, the log analyzer may determine whether the number of documents searched by the query exceeds a threshold. For example, the log analyzer may determine that 75% of the documents in the document corpus were searched to respond to a particular query and, therefore, the particular query is expensive. In some implementations, the log analyzer may use an actual number of documents rather than a percentage. The threshold value may be set by a system administrator to any value considered sufficiently high, considering that a higher number of documents searched indicates a higher expense for the query.

The log analyzer may also analyze a recurring query to determine whether all search results were requested (step 210). For example, some search systems may provide a link, a button, or some other user interface element, with the first page of results that allows a query requestor to specify that all search results should be returned, not just the best matching results. If a query requestor selects this link (or other user interface element), the selection may be indicated in the log and the log analyzer may identify the event and flag the query as expensive. Such queries may be considered expensive because searching for all results rather than just the best matching requires more processing resources.

The log analyzer may also analyze the log file for a particular recurring query to determine the amount of time required to determine all responsive documents for the query (step 215). In some embodiments, the log analyzer may execute step 215 after identifying the selected link as part of step 210. In some embodiments the log analyzer may look at the total query run time independently of any selection of the link. If the log analyzer determines that the amount of time needed to return all results for the query exceeds a threshold then the log analyzer may consider the query expensive.

In some implementations the log analyzer may analyze recurring queries for other indications of expensiveness, such as a high percentage of low-ranking documents in the result list or a particular combination of regular expression operators. As will be recognized, the log analyzer may also analyze the log for other types of recurring queries, such as popular queries. While such queries may not be expensive to run once, there may be an advantage to caching their results to save cumulative processing resources. But, for the purposes of this disclosure, such queries are not considered expensive unless they also meet some other test for expensiveness.

After identifying a particular query as recurring and expensive, the log analyzer may store the parameters for the particular query in a data store (step 220). For example, the query parameters may be stored in a database file or a flat file, such as high-cost queries 136. The method of storage is not important so long as enough information is stored to enable the log analyzer to identify a later-submitted query as the same as one of the expensive recurring queries.

In some implementations the log analyzer may also maintain the list of high-cost recurring queries. For example, before analyzing the query log files the log analyzer may mark all the stored queries, such as high-cost queries 136, for deletion. Then, as the log analyzer identifies queries in the log file as expensive recurring queries the system may check to see if the query already exists in the data store. If a query does exist the log analyzer may remove the deletion indicator for that query. After all relevant log records have been analyzed the log analyzer may delete the records in the data store that are still marked for deletion. In this manner, the log analyzer may identify queries in the data store that are no longer expensive and recurring and delete those queries from the data store of high-cost recurring queries. In other implementations the log analyzer may use other methods of maintaining the list, such as deleting the list prior to re-creating the list etc.

At some point in time the query processer may receive a query submitted by a query requestor (step 225). As part of processing the query, the query processer may compare the query to the queries stored in the list of high-cost queries, for example high-cost queries 136 (step 230). If the query is not a high-cost recurring query (step 230, No), then the query processer may obtain the search results by executing the query (step 250). If the query matches one of the stored queries (step 230, Yes), then the query processer may obtain prepared results for the query (step 235). The prepared results, such as prepared results 138, may be a result list cached at the time that the query was identified as an expensive recurring query, or the prepared results may be a list of results that is updated as the document corpus is indexed, as explained in more detail below with regard to FIG. 3. The query processer can then use the prepared results to reduce the query latency.

For example, the query processer may provide the prepared results to the user as a first page of results rather than actually executing the query. This method may work well in systems with a low change rate for documents in the document corpus. In other implementations, the system may still execute the query and obtain a result list from the executed query (step 240). The query processer may blend the prepared results with the executed results (step 250). For example, the query processer may provide the prepared results as a first page that is shown to the user immediately, while the query is running in the background. Once the query has finished executing, the query processor may return the results list from the executed query as one or more additional pages, should the user request the additional pages. In other implementations, the prepared results may be used to provide help or a preview while the user is typing. In some implementations, the query processer may combine the prepared results with documents found through the query execution after some specified period of time. In such an implementation, the query processer may provide any additional documents returned after the specified period as part of a second page that loads after the query execution completes.

Whether the query is a high-cost recurring query or not, the query processer will provide query results to the query requestor (step 255). It will be apparent that using the prepared results for identified high-cost recurring queries will decrease the amount of time that the query requestor must wait to receive a search result for those queries because it reduces the load on the search system. In addition, implementations that use an updated list of prepared results will receive higher quality results.

FIG. 3 is a flow diagram illustrating a process 300 for updating prepared results for a high-cost recurring query, consistent with disclosed implementations. A search system may use an offline query processor, such as offline query processor 124, to execute process 300 and ensure that prepared results for a query remain fresh, thus increasing the quality of the prepared results, no matter how often the documents of a corpus change. The search system may incorporate process 300 into an indexing procedure so that the prepared results remain as current as the index, although process 300 may also be executed separately from the indexing process. At step 305, the offline query processer may identify a new or updated document from the document corpus. For example, the offline query processer may identify the document at indexing or the offline query processer may obtain the document from a list of documents that the indexer, such as indexer 120, created.

The offline query processer may also obtain parameters for a high-cost recurring query, for example from high-cost queries 136 (step 310). The high-cost recurring queries may have been identified using, for example, process 200 described above or a user may have requested that a particular query be included in the high-cost queries 136. Having obtained a document and parameters for a high-cost query, the offline query processer may determine whether the document matches the query parameters (step 315). In other words, the offline query processer may determine whether the document qualifies as a search result for a particular high-cost query. If so, the offline query processer may add the document to a prepared result list, such as prepared results 138, associated with the high-cost recurring query (step 320). In some implementations the offline query processer may optionally notify a query requestor for the high-cost query that a new document has been located that matches the query (step 322). In some implementations such notification may take place after the indexing process has completed.

The offline query processer may then determine whether any other high-cost recurring queries exist (step 325). If another high-cost query does exist, the offline query processer may obtain the parameters of the next query (step 330) and repeat steps 315 to 325 using the next high-cost query. In such a manner the offline query processer may add the document to prepared results for each query pre-identified as a high-cost recurring query. After the offline query processer inspects all such pre-identified queries process 300 may end for the particular document, although it will be apparent that the offline query processer may repeat process 300 for as many documents as needed.

In some implementations, before process 300 begins, the search system may store a version of the result list in an archive so that the prepared results may be analyzed to determine how the list changes over time. In some implementations the prepared results may be stored in the archive after process 300 ends.

The just described methods of identifying expensive recurring queries, generating prepared results for the identified queries, and using the prepared results to decrease query latency offer one solution for improving the efficiency and quality of searching large document corpora. Using suffix arrays as a prefilter for regular expression queries offers a second solution. Such a solution may be combined with the first or may be used independently. As discussed above, suffix arrays, such as array 140, may be created as part of the indexing process in a search engine. Search systems that allow searching by regular expressions may also use the suffix array to more efficiently prefilter documents, decreasing query latency and increasing the quality of the search results.

Disclosed implementations may use a prepend operation that prepends a character or a character string to a suffix array range. As discussed above, suffix array 405 of FIG. 4 illustrates a suffix array for document 400, and the starting position 407 for each entry is shown in hexadecimal numbers. In the example of FIG. 4, given suffix array range [0, 3], which corresponds to the strings ananas$, anana$ananas$, anas$, and ana$ananas$, the operation prepenkn′, [0, 3]) yields the suffix array range [7, 8], which corresponds to the strings nanas$, nana$ananas$, as shown in FIG. 4. In other words, the prepend operation adds the given character, or character string to the suffix array entries in the given range and returns the suffix array entries that match any of the newly created strings. In the example above, because nananas$ and nanana$ananas$ do not exist in the suffix array 405, the resulting suffix array range contains only two entries and not four. Some implementations of the prepend operation can be implemented with a Huffman wavelet tree, as described in “Succinct Suffix Arrays Based on Run-Length Encoding” by Val Mäkinen and Gonzolo Navarro, Nordic Journal of Computing (2005).

To determine the suffix array entries that match a given regular expression, the search system may use automatons. For example, the search system may create a non-deterministic automaton for the regular expression submitted as part of a search query. An automaton is self-acting state machine used to represent an infinite set. Each automaton has a beginning node, intermediate nodes, at least one termination node, and edges that connect the nodes. The search system travels from node to node using the edges. FIG. 5 illustrates an example of an automaton for the regular expression ‘an?a’. The ? operator indicates that the “n” character may occur zero or one times. In the automaton, Z is the starting node and may represent an empty string. To get from node Z to node Y, the system must match an ‘a’ character. Thus, at node Y, the output of the automaton is ‘a’. To get from node Y to node X, the system may use the empty edge (meaning no character is needed to get from node X to node W) or the ‘n’ edge. Thus at node X the output is either ‘an’ or still just ‘a’. Finally, to move from node X to node W, the system locates an ‘a’ character. At node W the output is ‘ma’ (if the ‘n’ edge was taken) or ‘aa’ (if the empty edge was taken). Both outputs match the original regular expression. Thus, documents containing either “ana” or “aa” would be considered responsive to a search query that included the regular expression “an?a.”

In order to determine what documents are responsive to the query with the “an?a” regular expression, disclosed implementations may work backwards from the termination node W to the beginning node Z using the prepend operation described above. Because the search system works backwards, a termination node represents every possible string, which is the full suffix array range. Thus, Range_W at node W for suffix array 405 of FIG. 4 is [0, D], or the entire array. To move backwards from node W to node X, the search system may prepend the value of the edge, in the example of FIG. 5, an ‘a’, to Range_W. For example to calculate Range_X the search system may prepend(‘a’, [0, D]), which results in a Range_X of [0, 5], or all suffix array entries that start with ‘a’. Because there are two edges that connect node X and node Y, the search system may perform an OR operation. For example, to calculate Range_Y the search system may “prepend(‘n’, Range_X) or Range_X.” In other words, Range_Y=prepend(′n′, [0, 5]) or [0, 5]=[7, A] or [0, 5]. Finally, to move from node Y to node Z, the system prepends an ‘a’, resulting in Range_Z=prepend(‘a’, [7, A]) or prepend(‘a’, [0, 5])=[0, 3] or [null]=[0, 3]. In such a manner, the search system may determine that the entries in positions 0-3 in the suffix array match the regular expression an?a. Based on the suffix array entries, the search system may then be able to determine which documents are associated with the entries and at what position(s) within the document(s) the entries occur. The search system may use this information to generate search results.

FIG. 6 illustrates an automaton for the more complex regular expression “a(na)+s.” The + operator indicates that the string “na” can be repeated one or more times. To account for the infinite repetition, the automaton of FIG. 6 has an empty backward edge from Node W to Node Y, creating a loop. However, because a search system consistent with disclosed implementations uses back-propagation, the search system cannot handle the backwards edge. To account for the edge, the search system may unroll the loop created by the “‘na+” term. Implementations of the search system may use various methods to accomplish the unrolling.

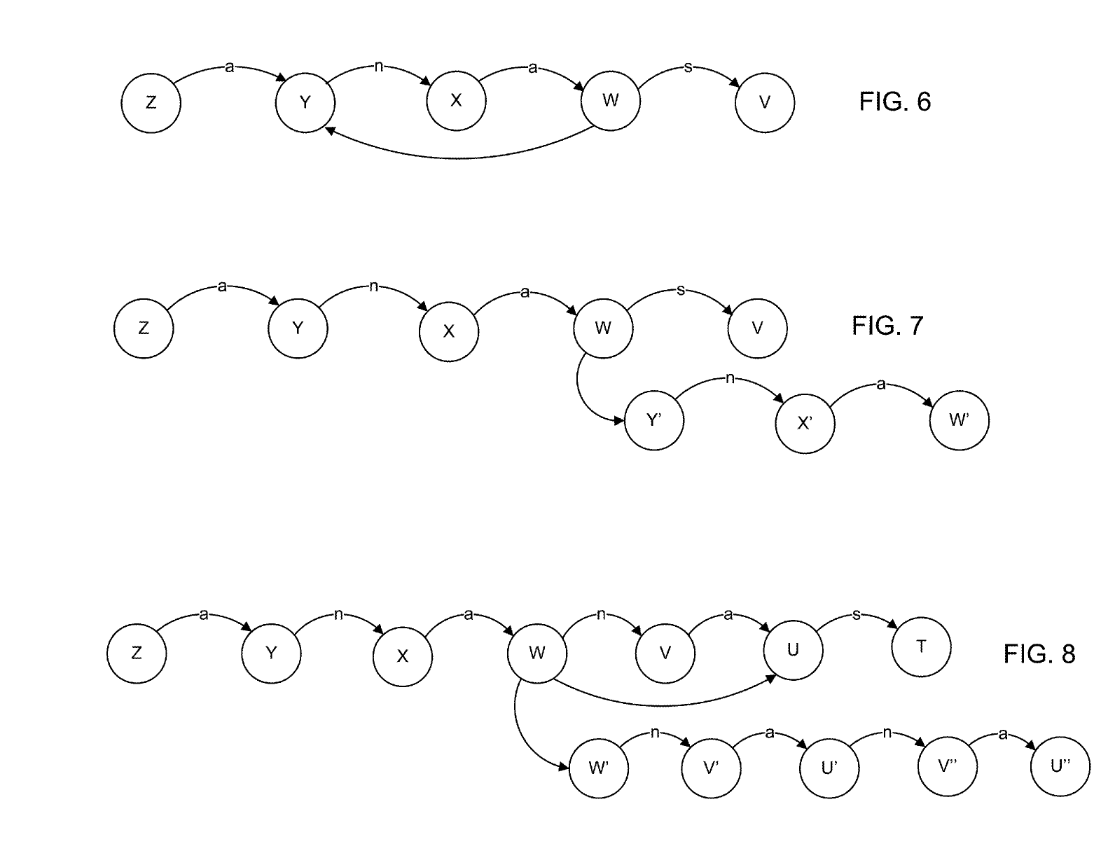

In some implementations, the search system may create the automaton shown in FIG. 7. The search system may create the Y′, X′, and W′ nodes to account for the repetition of the “na” term. Because of this branch, the automaton of FIG. 7 has two termination nodes, namely W′ and V. Thus, the search system may traverse the automaton starting with node V and, separately, with node W′. When the search system reaches node W, the search system will calculate Range_W as equal to prepend(‘s’, Range_V) or Range_Y′, similar to the calculation of Range_Y in FIG. 5. After fully traversing the automaton of FIG. 7, starting with Range_V and Range_W′, the search system will determine Range_Z is [0, 2], which represents the first three entries in the suffix array 405, namely “anas$,” “‘anana$ananas$,” and “ananas$”.

However, the automaton of FIG. 7 finds more matches than it should. Specifically, the automaton results in three matches although only “anas$” and “ananas$” match the regular expression. While having an extra match for a prefilter is not necessarily an error, it does result in having to search documents unnecessarily, which increases the use of processing resources. Therefore, some implementations of the search system may create the automaton shown in FIG. 8. This automaton represents the following cases: 1) “na” occurs once, 2) “na” occurs twice, and 3) “na” occurs three or more times. From node W, the empty edge to U accounts for case 1, the “n” edge accounts for case 2, and the empty edge branching to W′ accounts for case 3. This automaton finds exactly the two entries in the suffix array that match the regular expression. To show how the search system arrives at the two suffix array entries, the suffix array ranges for each node of the automaton of FIG. 8 are noted in the table below, where p( ) is the prepend( ) function.

TABLE 1
Range_T = [0,D]

| Range_U = p(‘s’, Range_T) = prepend(‘s’, [0,D]) | = [B,B] |
|---|---|
| Range_V = p(‘a’, Range_U) = prepend(‘a’, [B,B]) | = [4,4] |
| Range_V″ = p(‘a’, Range_U″) = prepend(‘a’, [0,D]) | = [0,5] |
| Range_U′ = p(‘n’, Range_V″) = prepend(‘n’, [0,5]) | = [7,A] |
| Range_V′ = p(‘a’, Range_U′) = prepend(‘a’, [7,A]) | = [0,3] |
| Range_W′ = p(‘n’, Range_V′) = prepend(‘n’, [0,3]) | = [7, 8] |

Range_W = p(‘n’, Range_V) or Range_U or Range_W′ =

p(‘n’, [4,4]) or [B,B] or [7,8] = [9,9] or [B,B] or [7,8] = [B,B] or
[7,9]

| | |
|---|---|
| Range_X = p(‘a’, Range_W) = p(‘a’, [B,B]) or | = [4,4] or [0,2] |
| p(‘a’,[7,9]) | |
| Range_Y = p(‘n’, Range_X) = p(‘n’,[4,4]) or | = [9,9] or [7,7] |
| p(‘n’, [0,2]) | |
| Range_Z = p(‘a’, Range_Y) = p(‘a’,[9,9]) or | = [0,0] or [2,2] |
| p(‘n’,[7,7]) | |

The unrolling of the “na” term three times is used as an example. The term may be unrolled any number of times, although this takes more processing time. In some implementations, the search system may employ a dynamic unrolling. In other words, the search system may begin by unrolling the term twice, as shown in FIG. 7 and then three times, as shown in FIG. 8, and compare the number of suffix array entries found by each automaton. If the number of entries does not decrease significantly, then the search system may stop because further unrolling will fail to provide a further narrowing of the documents. In other words, the system may compare the results of two automaton to determine whether the processing time needed to further unroll a repeated term is justified based on the further elimination of documents. In some implementations the unrolling may be done incrementally using an operator tree instead of an automaton. For example, given the intervals for an n-times unrolled loop, the automaton module may compute the interval for an (n+1)-times unrolled loop. Thus, the automaton module need not restart from the beginning of the tree to determine the intervals before determining whether the interval difference is significant. A significant decrease using either the automaton or the tree may be a decrease of, for example, 10% or more. In some implementations this decrease may be measured over a predetermined number of iterations, such as 3, rather than just the next iteration.

The suffix array of FIG. 4 contains very few entries for the sake of brevity and ease of explanation, but in practice the suffix array may contain millions of entries. With such large suffix arrays, to conserve memory, the suffix array may not store the starting position 407 of the string corresponding to the suffix array entry. Rather, the search system may use the suffix array index to map to the starting position through the use of a range query data structure. A range query data structure is used to represent general integer-to-integer mappings (e.g., a map[i] function) with only slightly more memory usage than a straightforward representation of an array, but the range query data structure dramatically reduces the theoretical complexity of range queries (e.g., enumerate all integers of the set j₀<=map[i]<=j₁, where i₀<=i<=i₁). In document searching and ranking, it is important to know the position of each string within the document (e.g., where in the document the strings occur in the document). The range query data structure provides this answer by mapping the positions of the suffix array (the i values) to document positions (the j values) in order of appearance within the document. Some range query data structures use a bitmap binary tree structure for the mapping. The leaves of the tree are the document positions in sorted order (the j values). The nodes of the tree indicate the path to the correct leaf node, with the values in the root node mapping directly to the suffix array positions (the i values). Only the leaves of the tree contain values (the j values).

To traverse a range query data structure, a traverser starts with a position of the suffix array (the i value). The suffix array position corresponds to a bit of the bitmap stored at the root node. The values in the root node (L0) bitmap of a range query data structure represent the next node to be traversed in the tree. For example, at suffix array position zero, the root node may contain a one, indicating that the traverser function should follow the right branch of the tree to the next level (L1). Index position one of the root node may contain a zero, indicating the left branch to the next level (L1) should be followed. To determine what index position to examine in the next node (in L1), the traverser function may count the zeros or ones that occur before the position being examined in the current node. For example, starting with the rth position in the root node, if the rth position contains a zero, the number of zeros preceding the rth position indicates where in the left node down the desired bit position is located. For example, if index position 5 in the root contains a zero, and there are two zeros ahead of it in the root node, then in the next level down (L1), the system should look at the left hand node in index position 2. Index position 2 in L1 may have a zero with no zeros ahead of it, meaning that the traverser function should go to the left hand node of the next level down (L2) and examine index position zero of the left node in L2. Index position zero in the node in L2 may be a one, indicating that the traverser function should take the right branch to L3, and inspect index position zero (because there are no ones ahead of index position zero). Finally, index position zero in L3 may be a zero, indicating the traverser function should go to the left leaf node in L4. The left leaf node in L4 may contain a “2,” representing the starting index position in a document for the string found at index position 5 of the suffix array. In this manner, a traverser function can traverse the tree to map index position 5 (the i value of 5) to a “2” (the j value).

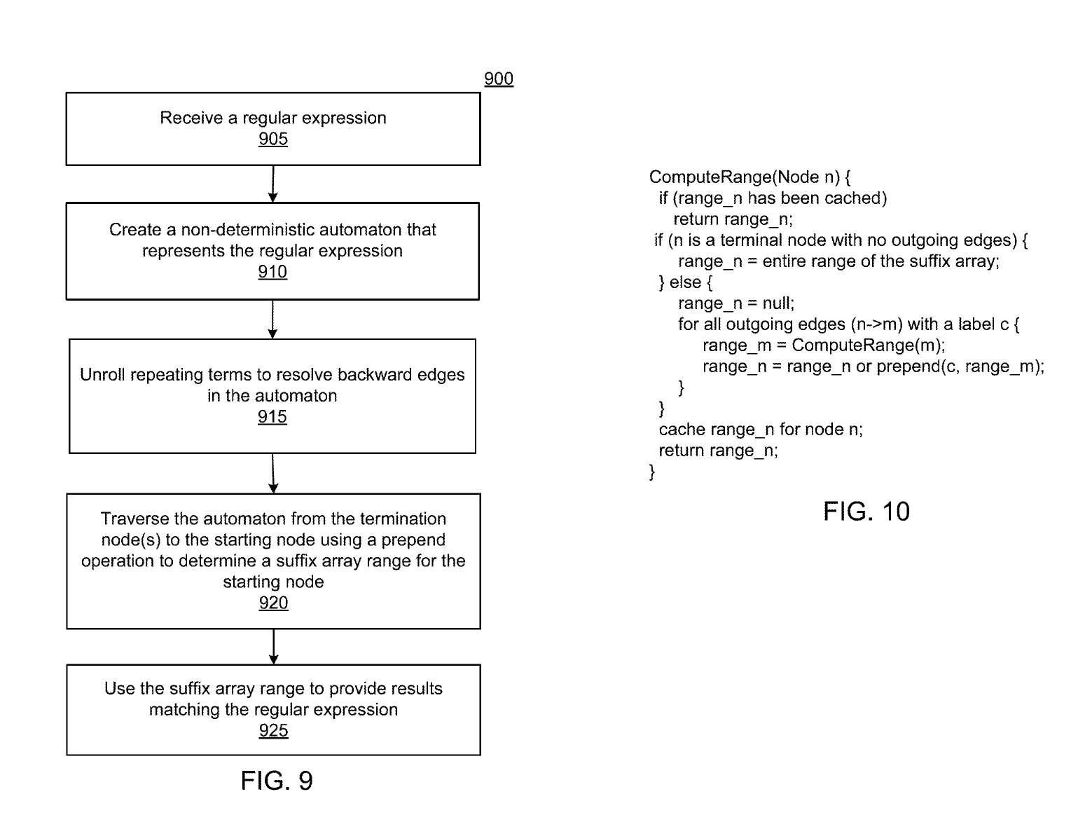

FIG. 9 is a flow diagram illustrating a process 900 for using a suffix array to prefilter documents matching a regular expression, consistent with disclosed implementations. The search system may use an automaton module of a query processor, such as automaton module 129, to perform process 900 as part of a query response. Process 900 may allow the automaton module to build and traverse the automaton described above with regard to FIGS. 5, 7, and 8. At step 905, the automaton module may receive a regular expression, for example, as part of a query submitted by a requestor. A regular expression may include phrases or substrings, which are special cases of regular expressions. The automaton module may then create an automaton for the regular expression (step 910). The automaton module may unroll one or more repeating terms in the regular expression, if they exist, to resolve backward edges in the automaton (step 915). The automaton module may traverse the automaton from the termination node(s) to the starting node using a prepend operation to determine a suffix array range for the starting node (step 920). In some implementations, the unrolling may be done a pre-determined number of times. In some implementations, unrolling may be dynamic. To determine the number of times to unroll a backward edge, the automaton module may repeat steps 915 and 920 until a comparison of the suffix array range associated with each successive automaton shows no significant decrease. The suffix array range for the starting node represents documents potentially matching the regular expression. Once the range is found, the query processor may use the range to provide documents that match the regular expression as part of a result list (step 925).

FIG. 10 illustrates example pseudo code for traversing the non-deterministic automaton to determine a suffix array range for the starting node, consistent with disclosed implementations. The automaton module may use the pseudo code of FIG. 10 as part of step 920 of FIG. 9. The automaton module may begin at a starting node of the automaton. The automaton module may then determine whether the range for the starting node has been cached. If so, the range is returned. Otherwise, the automaton module may set the range for the node to null, in other words an empty range. The automaton module may then calculate the range by determining the range for each outgoing edge (range_m=ComputeRange(m)) and prepend the value of the outgoing edge to the range. Determining the range for each outgoing edge may include a recursive call to the ComputeRange function, so that the first node to have its range cached is a terminal node.

For example, in the automaton of FIG. 7, the automaton module may call ComputeRange(Z) for node Z. Since the range for Z is not cached, Range_Z is set to null and the automaton module may call ComputeRange(Y) for node Y. The recursive calls to ComputeRange( ) may continue until the automaton module calls ComputeRange(V) for node V. Since this is a termination node, there are no outbound edges and Range_V remains null. Thus, the automaton module may set Range_V to the full array range [0,D], cache this range, and return Range_V. This range is returned to the for loop for node W and, after it is returned, the automaton module may set Range_W to prepend(‘s’, Range_V). Because there is another outbound edge from node W, the automaton module may make recursive calls to ComputeRange( ) until it determines Range_W′ for node W′. As the ranges of the respective nodes between W′ and Y′ are returned from the recursive calls to ComputeRange( ) with each node's range being cached, eventually Range_W is determined to be prepend(‘s’, Range_V), which was previously saved as Range_W, OR Range_Y′. Range_W is then cached and returned, allowing the automaton module to eventually determine Range_Z. As is apparent from this example, the ranges for the termination nodes of the automaton are determined and cached first, with the ranges for the nodes leading to the termination nodes cached next, etc., so that the automaton is traversed from the termination nodes to the starting node.

In other implementations, the search system may use a regular expression operator tree rather than an automaton to determine the suffix array range. A regular expression operator tree may include a root operator with child nodes. Each child node may be another operator or a character node. Character nodes may be considered leaf nodes for the tree. For example, the regular expression “a(na)+s” may have an operator tree like that shown in FIG. 13. In the example of FIG. 13, the root node is a “concat” operator and its children are the “a” character node, the “n” character node, another “a” character node, a “repetition” operator node, and an “s” character node. The “repetition” operator node has one “concat” operator node as a child. This node has two child nodes, an “n” character node and an “a” character node. Because the “+” operator indicates the “na” term should occur one or more times, the “n” and “a” character nodes are children of the root node. This takes care of the case where “na” occurs once. The repetition node can occur zero or more times and accounts for the case where “na” occurs more than the one time.

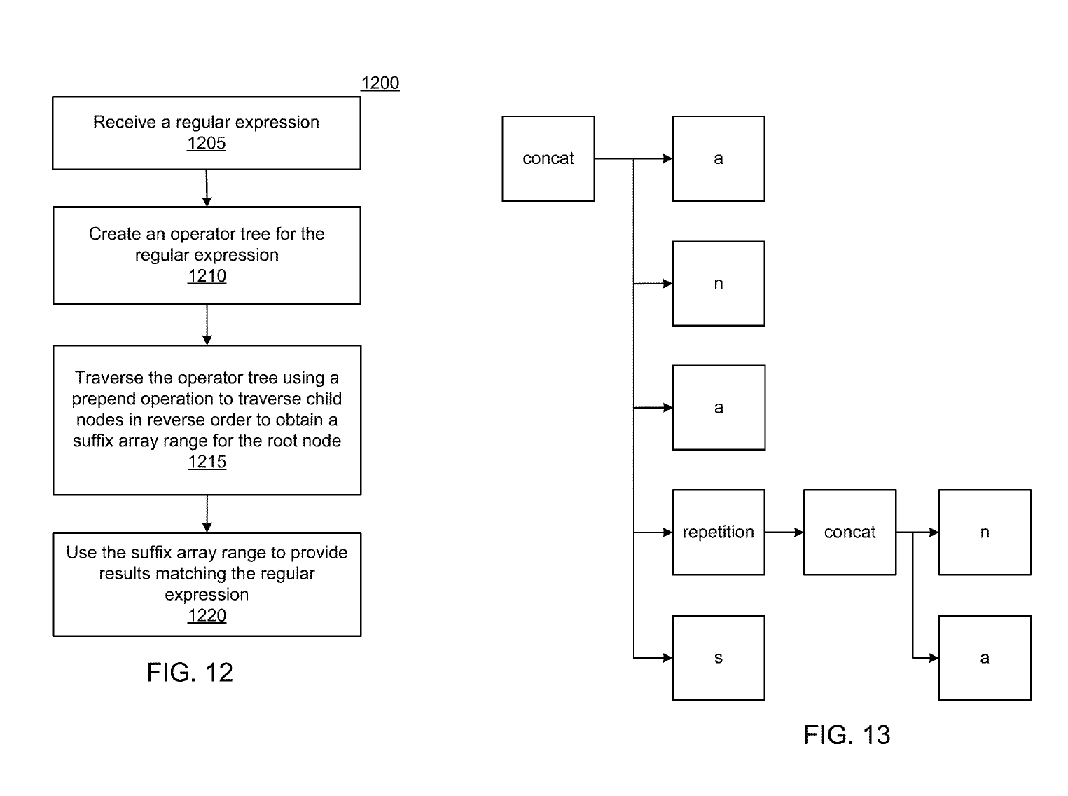

FIG. 12 is a flow diagram illustrating another process 1200 for using a suffix array to prefilter documents matching a regular expression, consistent with disclosed implementations. Process 1200 may allow the automaton module to build the regular expression operator tree and traverse the tree, described above with regard to FIG. 13, to determine a suffix array range. At step 1205, the automaton module may receive a regular expression, for example, as part of a query submitted by a requestor. From the regular expression, the automaton module may build an operator tree for the regular expression, such as the tree shown in FIG. 13 that corresponds to the regular expression “a(na)+s.” The automaton module may traverse the operator tree using a prepend operation to determine the suffix array range for the root node. In traversing the tree, the automaton module may begin with the root node, for example the “concat” node, with the full suffix array range and determine the suffix array range for each of the children of the root node, starting with the last child. In other words, the automaton module may determine the suffix array range for the “s” child node first, the repetition operator node next, etc. Like the automaton above, this may be accomplished using a prepend operation. Once the automaton module has determined the starting range for the root node, the query processor may use the range to provide documents that match the regular expression as part of a result list (step 1220).

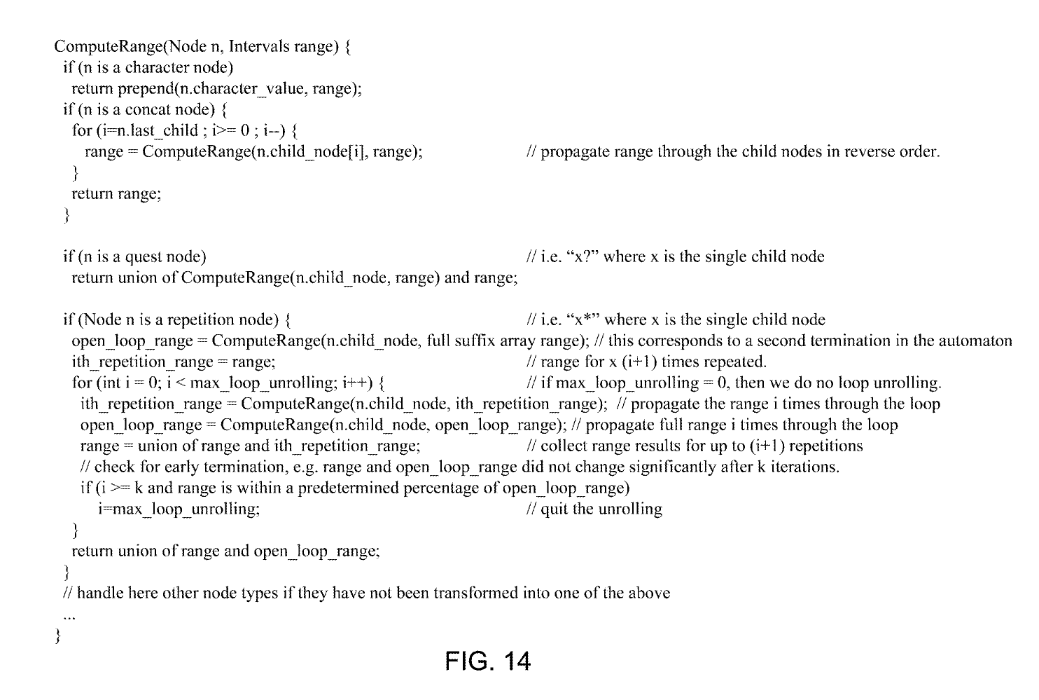

FIG. 14 illustrates an example of pseudo code for traversing the operator tree to determine a suffix array range for the root node, consistent with disclose implementations. The automaton may use the pseudo code of FIG. 14 as part of step 1215 of FIG. 12. As the example of FIG. 14 shows, the automaton module may determine how many times to repeat the “na” term incrementally by comparing the suffix array ranges calculated for a predetermined number of iterations. The automaton module may begin by calling the ComputeRange( ) function for the root node using the entire suffix array range. Using the example of FIGS. 4 and 13, the automaton module would issue a call resembling ComputeRange(“concat” “[0,D]”). Because the root node is a concat node, the automaton module will calculate the range through the child nodes in reverse order, starting with the “s” character node with a recursive call resembling ComputeRange(“s”, “[0,D]”). The automaton module may calculate the range for “s” by prepending the character “s” to the given range, in this case[0, D].

The automaton module may then calculate the range for the “repetition” operator” using the range for the “s” node. The pseudo code of the “repetition” node may perform a number of iterations, bound by the value of max_loop_unrolling, stopping the iterations when the suffix array range does not significantly change. As indicated above, significance may be determined by a system administrator and be based on a predetermined number, such as 10%. The following table illustrates the values of the ith_repetition_range, open_loop_range, and range before the repetition node and for two iterations of the repetition node for the regular expression ana(na)*s using suffix array 405, with the string represented by the range (409) substituted for the range values for clarity:

| | ith_repetition_range | open_loop_range | range |
|---|---|---|---|
| Before | “s” | “nanas” or | “s” |
| the loop | | “nana$ananas” or | |
| | | “nas” or “na$ananas” | |
| i = 0 | “nas” | “nanas” or | “s” or “nas” |
| | | “nana$ananas” | |
| i = 1 | “nanas” | Empty set (no | “s” or “nas” or |
| | | “nanana entries) | “nanas” |

From the table above one can see that the number of entries in open_loop_range decrease over time where the number of entries in range increase. Thus, the automaton module may know that further unrolling is unnecessary when the number of entries in range comes within a predetermined percentage of the number of entries in open_loop_range because the number of entries in range will not increase significantly after that point. When an appropriate suffix array range for the “repetition” node is determined, the automaton module may then determine the range for the “a” character node by prepending the “a” to the range determined for the “repetition” node. The automaton may then prepend “n” to this range to determine the range for the “n” character node. Finally, an “a” may be prepended to the suffix array range for the “n” character node. This range may be assigned to the root node and the automaton module may pass this range to the query processor as the prefiltered range. The query processor may use this range to determine documents responsive to the regular expression. In this manner the automaton module may traverse the children of the root node in reverse order to determine a suffix array range for the root node of the operator tree using incremental unrolling.

It will be understood that the regular expression prefilter processes described above may be used independently of other methods for improving search query latency, or the processes may be used in combination with other methods or with each other. While the combination offers the greatest latency improvements for searching a document corpus with regular expressions, the described suffix array prefilter processes offer significant improvements of their own for such searches. For example, where a prefilter tree can grow exponentially, in a worst-case scenario the suffix array prefilter is limited by the number of characters in the document. Moreover, the automaton module may be configured to account for worst-case scenarios. For example, when the Range_Z of the starting node, or any other node, results in a large number of small intervals, the automaton module may approximate the range by adding the gap between one or more intervals to the output range. A small interval may be determined by a predetermined threshold, such as a number or a percentage of the total number of entries in the suffix array. The automaton module may add gaps to neighboring intervals until the total number of intervals is below a certain limit. In some implementations, the automaton module may add gaps to neighboring intervals when the total number of intervals exceeds a certain threshold. Merging such gaps may save processing time during the prefiltering. In some implementations, the smallest gaps may be added first to achieve optimal approximation. While this action may result in more selections, the processing savings may compensate for the increased number of documents. Finally, in most scenarios, the suffix array prefilter is more selective than the prefilter tree, resulting in faster search results.

FIG. 11 shows an example of a generic computer device 1100 and a generic mobile computer device 1150, which may be used with the techniques described here. Computing device 1100 is intended to represent various forms of digital computers, e.g., laptops, desktops, workstations, personal digital assistants, servers, blade servers, mainframes, and other appropriate computers. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, for example, display 1116 coupled to high speed interface 1108. In some implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, for example, a magnetic or optical disk.

The storage device 1106 is capable of providing mass storage for the computing device 1100. In one implementation, the storage device 1106 may be or contain a computer-readable medium, for example, a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, for example, the memory 1104, the storage device 1106, or memory on processor 1102.

The high speed controller 1108 manages bandwidth-intensive operations for the computing device 1100, while the low speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, for example, a keyboard, a pointing device, a scanner, or a networking device, for example a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer like laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provided in communication with processor 1152, so as to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provided as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smart phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” and “computer-readable storage device” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for prefiltering documents for a query, the method comprising:
receiving a regular expression;
creating, using at least one processor, an automaton representation of the regular expression, the automaton having a starting node, a number of termination nodes, and at least one edge between nodes;
traversing, by the at least one processor, the automaton from the termination nodes to the starting node to identify a suffix array range for the starting node; and
using the suffix array range to identify documents responsive to the regular expression.

2. The method of claim 1, wherein traversing the automaton includes using a prepend operation to move between nodes of the automaton.

3. The method of claim 2, wherein the prepend operation includes:
determining a value represented by an edge connecting a particular node to another node;
appending the value to suffix array entries corresponding to the another node; and
determining a suffix array range corresponding to the particular node based on the appending.

4. The method of claim 3, wherein the automaton has two terminal nodes, the another node has two forward edges, a first edge connecting the another node to the particular node and a second edge connecting the another node to a third node, and wherein determining the suffix array range that corresponds to the another node includes determining a union of suffix array ranges.

5. The method of claim 1, wherein each of the number of termination nodes corresponds to a suffix array range representing the entire suffix array.

6. The method of claim 1, wherein creating the automaton representation includes:
identifying a regular expression operator that creates a loop in the automaton; and
unrolling the loop at least one time, causing the automaton to have at least two termination nodes.

7. The method of claim 6, wherein the unrolling occurs a number of times, the number being dynamically determined.

8. The method of claim 1, wherein as part of identifying the suffix array range for the starting node the method further comprises:
merging neighboring intervals of the suffix array range when a gap between the neighboring intervals meets a first threshold or when the number of intervals in the suffix array range exceeds a second threshold.

9. A system comprising:
one or more processors; and
a memory storing instructions that, when executed by the one or more processors, perform operations comprising:
identifying expensive recurring queries in a log file of queries submitted to a search engine, wherein the expensive recurring queries are expensive based on a single query execution,
storing query parameters of the identified queries in a data store,
receiving a query including query parameters from a user,
determining whether the query parameters match any of the stored query parameters in the data store,
when it is determined that the query parameters match parameters for a particular stored query, using prepared results associated with the particular query to generate data used to display search results to the user;
determining whether the query includes a regular expression;
creating, when the query includes a regular expression, an automaton representation of the regular expression, the automaton having a starting node, a number of termination nodes, and at least one edge between nodes;
traversing the automaton from the termination nodes to the starting node to identify a suffix array range for the starting node;
using the suffix array range to identify documents; and
using at least some of the identified documents to generate data used to display the search results to the user.

10. The system of claim 9, wherein entries in the log file older than a specified date are not considered when identifying expensive recurring queries.

11. The system of claim 9, wherein identifying expensive recurring queries includes instructions that cause the one or more processors to locate a request to view all results for a particular query.

12. The system of claim 11, wherein identifying expensive recurring queries further includes instructions that cause the one or more processors to:
determine an amount of time that elapsed to arrive at a result for a particular query; and
identify the particular query as an expensive query when the amount of time that elapsed exceeds a threshold.

13. The system of claim 9, wherein identifying recurring queries further includes instructions that cause the one or more processors to:
identify a number of documents searched by a particular query; and
identify the particular query as an expensive query when the number of documents searched exceeds a threshold.

14. The system of claim 9, wherein using the prepared results includes instructions that cause the one or more processors to generate a first page of search results for display to the user from the prepared results, wherein the first page of search results is generated upon determining that the query parameters match.

15. The system of claim 14, the instructions further causing the one or more processors to perform operations comprising:
executing the query; and
identifying execution results,
wherein the execution results are used to generate a second page of search results for display to the user.

16. The system of claim 15, wherein the second page is displayed to the user in response to receiving an instruction from the user to display a next page.

17. The system of claim 9, wherein the prepared results associated with the particular query are used to generate data displayed to the user as the user types the query parameters.

18. The system of claim 9, wherein the instructions further cause the one or more processors to perform operations comprising:
receiving a document for indexing,
determining whether the document matches parameters of the particular query in the data store, and
adding the document to the prepared results associated with the particular query when it is determined that the document matches the parameters of the particular query,
wherein the receiving, determining, and adding occur independently from execution of the particular query.

19. The system of claim 18, the instructions further causing the one or more processors to performing operations comprising:
notifying a user associated with the particular query when the document is added to the prepared results.

20. The system of claim 18, wherein the instructions further cause the one or more processors to perform operations comprising:
archiving the prepared results before adding the document to the prepared results.

21. A computer-readable storage device for efficiently searching a source code repository, the storage device having recorded and embodied thereon instructions that, when executed by one or more processors of a computer system, cause the computer system to:
receive a query including query parameters from a user;
determine whether the query parameters include a regular expression;
create, when the query parameters include a regular expression, an automaton representation of the regular expression, the automaton having a starting node, a number of termination nodes, and at least one edge between nodes;
traverse the automaton from the termination nodes to the starting node to determine a suffix array range for the starting node;
use the suffix array range to identify documents in the source code repository;
determine whether the query parameters match query parameters stored in a data store, wherein the data store identifies expensive recurring queries;
when it is determined that the query parameters match parameters for a particular query stored in the data store, identify documents associated with prepared results for the particular query; and
generate data used to display search results to the user, the search results including the documents associated with the prepared results and at least some of the documents identified using the suffix array range.

22. The storage device of claim 21, wherein the instructions further cause the computer system to:
receiving a document for indexing,
determining whether the document is responsive to the particular query in the data store, and
adding the document to the prepared results associated with the particular query when it is determined that the document is responsive,
wherein the receiving, determining, and adding occur independently from execution of the particular query.

23. The storage device of claim 21, wherein expensive recurring queries include queries derivable from a parent query and as part of identifying documents associated with prepared results for the particular query the instructions further cause the computer system to:
identify the particular query as a member of a family of queries;
identify prepared search results for the family of queries; and
search the prepared search results for the family of queries for documents matching the particular query.

24. A computer-implemented method for prefiltering documents for a query, the method comprising:
receiving a regular expression;
creating, using at least one processor, an operator tree for the regular expression, the operator tree having a root node and a number of child nodes;
traversing the child nodes in reverse order to identify a suffix array range for the root node; and
using the suffix array range to identify documents responsive to the regular expression.

25. The method of claim 24, wherein traversing the child nodes includes:
determining a first suffix array range for a number of repetitions of a repeated term in the regular expression;
determining a second suffix array range for the number of repetitions plus one of the term repetitions;
comparing the first suffix array range and the second suffix array range; and
avoiding the determining of a third suffix array range for the number of repetitions plus two for the repeated term based on the comparison of the first suffix array range and the second suffix array range.
